(19) United States
(12) Patent Application Publication
(10) Pub. No.: US 2020/0207585 A1
(43) Pub. Date: Jul. 2, 2020

(54) ELEVATOR CAB WALL PROTECTION PANEL AND USE THEREOF

(71) Applicant: Debra Carole Gettling, New Westminster (CA)

(72) Inventor: Debra Carole Gettling, New Westminster (CA)

(21) Appl. No.: 16/243,078

(22) Filed: Jan. 9, 2019

Related U.S. Application Data
(60) Provisional application No. 62/683,911, filed on Jun. 12, 2018.

(51) Int. Cl. B66B 11/02

(52) U.S. Cl. CPC B66B 11/0253

(57) ABSTRACT

Methods and apparatus for protecting an interior wall of an elevator cab against an impact force are disclosed. One such apparatus includes a face sheet for absorbing and dispersing energy from the impact force. It also includes a reversibly deformable backing connected to a back of the face sheet for absorbing energy from the impact force when the reversibly deformable backing is compressed against the interior wall by the impact force. The reversibly deformable backing is positioned between the face sheet and the interior wall when the elevator cab wall protection panel is installed. The face sheet has a higher rigidity than the reversibly deformable backing. The apparatus further includes a hanging apparatus coupled to an edge of the face sheet for hanging the elevator cab wall protection panel adjacent to the interior wall.

### TECHNICAL FIELD

The present invention relates generally to the field of elevators and more specifically to an elevator cab interior protection system.

### BACKGROUND

Elevators in a residential, commercial and industrial building are high traffic areas in which both people and materials are vertically moved. Passenger elevators are often finished with decorative and aesthetic panels that are made of wood, fabric, metal, mirrors or other materials that could be scratched or otherwise marred when moving large items or large quantities of items. In many buildings, a freight elevator does not exist, so the regular passenger elevator is used for moving items in and out of the building. Unless the elevator cabs and walls are protected, this often results in damage, from scratches and surface nicks to significant impact dents and breakages.

As it would be highly inconvenient, expensive and impractical for elevators to be taken out of service to repair frequent damage to the interior of the elevator cab occasioned by such moves, it is instead a common practice to suspend blanket-like pads over the panels in such elevators to protect against damage. Pads may also be used during servicing of the elevator. Typically, specialized pads for use in elevators are required to properly protect the panels. These elevator pads are clipped to the walls of the elevator or otherwise attached by a metal hanger or by another type of hardware. The pads include holes in the pad itself arranged at certain intervals along a top edge of the pad to attach to a peg or post in the elevator.

There exists a continuing desire to advance and improve technology related to elevator cab wall protection.

### SUMMARY

According to one aspect of the present disclosure, there is provided an elevator cab wall protection panel, for removable hanging in an elevator. It includes a face sheet having a top, a bottom, two opposing sides, a front surface and a back surface. The face sheet is substantially flat, and of flexible and lightweight material. The front surface of the sheet, when the panel is in place and hanging in an elevator, is exposed and visible to an interior of the elevator. The panel further includes a foam backing, adhered to the back surface of the face sheet and having sufficient thickness and compression rigidity to buffer impacts to the elevator cab wall during, for example, moving of objects in the elevator. The present disclosure further provides a system of multiple elevator cab wall protection panels, as described and claimed herein, for use on all walls and/or doors of an elevator cab.

According to another aspect, there is provided an elevator cab wall protection panel, for temporary installation in an elevator cab to protect an interior wall of an elevator cab against an impact force. The protection panel includes a face sheet for absorbing and dispersing energy from the impact force. The protection panel also includes a reversibly deformable backing connected to a back of the face sheet for absorbing energy from the impact force when the reversibly deformable backing is compressed against the interior wall by the impact force. The reversibly deformable backing is positioned between the face sheet and the interior wall when the elevator cab wall protection panel is installed. The face sheet has a higher rigidity than the reversibly deformable backing. The protection panel also includes a coupling apparatus coupled to an edge of the face sheet for reversibly installing the elevator cab wall protection panel adjacent to the interior wall. The elevator cab wall protection panel has sufficient rigidity to remain upright, during installation of the elevator cab wall protection panel, while held suspended above the ground from a central portion of each of at least one vertical axis running along the length of the elevator cab wall protection panel.

The coupling apparatus may also include a hanging apparatus coupled to a top edge of the face sheet for hanging the elevator cab wall protection panel adjacent to the interior wall.

The reversibly deformable backing may have a thickness sized to allow a predetermined depth of compression upon application of a predetermined minimum force.

The reversibly deformable backing may have a thickness sufficient to fill a space between the back of the face sheet and the interior wall when the elevator cab wall protection panel is installed in the elevator cab.

According to another aspect, there is provided a method for reducing the energy of impact forces transferred to an interior wall of an elevator cab. The method includes installing an elevator cab wall protection panel adjacent to the interior wall, dispersing energy from an impact against the elevator cab wall protection panel along at least a portion of a surface of a face sheet of the elevator cab wall protection panel, absorbing energy from the impact through compression and flexion of the face sheet and absorbing energy from the impact by compressing a portion of a reversibly deformable backing coupled to a back of the face sheet. The area of the compressed portion is behind the portion of the surface of the face sheet along which the energy is dispersed and the compressed portion is compressed between the face sheet, which has a higher rigidity than the reversibly deformable backing, and the interior wall.

The elevator cab wall protection panel may have sufficient rigidity to remain upright, during installation of the elevator cab wall protection panel, while held suspended above the ground from a central portion of each of at least one vertical axis running along the length of the elevator cab wall protection panel.

Installing the panel may include hanging the elevator cab wall protection panel from pre-existing supports inside an elevator cab using hangers coupled to a top edge of the elevator cab wall protection panel.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments,

FIG. 1 shows a perspective view of an elevator cab wall protection panel in accordance with the invention;

FIG. 2a shows a side view of the elevator cab wall protection panel of FIG. 1;

FIG. 2b shows front view of the elevator cab wall protection panel of FIG. 1; and

FIG. 3 shows a block diagram of a method for protecting an interior wall of an elevator cab from impacts.

### DETAILED DESCRIPTION

Directional terms such as “top”, “bottom”, “upper”, “lower”, “left”, “right”, and “vertical” are used in the following description for the purpose of providing relative reference only, and are not intended to suggest any limitations on how any article is to be positioned during use, or to be mounted in an assembly or relative to an environment unless otherwise stated. Additionally, the term “couple” and variants of it such as “coupled”, “couples”, and “coupling” as used in this description are intended to include indirect and direct connections unless otherwise indicated. For example, if a first device is coupled to a second device, that coupling may be through a direct connection or through an indirect connection via other devices and connections. The terms “an aspect”, “an embodiment”, “Embodiment”, “embodiments”, “the embodiments”, “one or more embodiments”, “some embodiments”, “certain embodiments”, “one embodiment”, “another embodiment” and the like mean “one or more embodiments of the disclosed invention(s)”, unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The phrase “at least one of ”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things does not mean “one of each of” the plurality of things.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represents” and like terms are not exclusive, unless expressly specified otherwise. For example, the term “represents” does not mean “represents only”, unless expressly specified otherwise. In other words, the phrase “the data represents a credit card number” describes both “the data represents only a credit card number” and “the data represents a credit card number and the data also represents something else”.

As discussed earlier, elevator walls inside an elevator cab may be damaged by forceful impacts. It is a common practice to suspend blanket-like pads over the walls in such elevators to protect against damage. However, currently known and used pads have disadvantages. They are often matted flexible blankets, textile pads or quilted pads outfitted along a top border with holes or grommets, hooks and or clamps for hanging. Regardless of pad type, the manner of hanging within the elevator cab generally provides a dead space of from 1-4 inches from the hanging pad to the actual wall surface of the cab. What this means is that a heavy and/or large object, slammed into the pad, as is often the case in moves, will often hit a wall (after hitting the pad) and create some level of damage even though the protective pad is in place. The dead space behind the hanging pad permits this connection. Additionally, pads are reused and are difficult to clean due to the quilting, so they are often unsightly, stained and/or odorous.

In the present disclosure, an elevator cab wall protection panel is provided for removable hanging in an elevator which, in some embodiments, fills the dead space with a foam backing. In certain embodiments, the elevator cab wall protection panel comprises a face sheet having a top, a bottom, two opposing sides, a front surface and a back surface. The face sheet is substantially flat, and of flexible and lightweight material. The front surface of said sheet (when the panel is in place and hanging in an elevator), is exposed and visible to an interior of the elevator. The panel further comprises a foam backing, adhered to the back surface of the face sheet and having sufficient thickness and compression rigidity to buffer impacts to the elevator cab wall, during moving of objects in the elevator. (Elevator cab wall protection panel, protection panel, and panel are all used interchangeably in the present disclosure. Other terms may also be used for the elevator cab wall protection panels.)

In some embodiments, the panel (in particular the face sheet of the panel) may be comprised of materials which make it reusable, leakproof, waterproof, water resistant, dust free and durable.

In some embodiments, a face sheet, which may be substantially flat and of flexible and lightweight material, may be coupled to any one of a plurality of configurations of foam backing material (more details on such configurations below). The foam backing material may provide a resilient buffer against damage to an elevator cab wall from objects within. Advantageously, the use of a foam backing material obviates the need for thick, heavy, and difficult to manage or hang quilted pads as the lightweight face sheet is not, by itself, providing the entire barrier functionality. The barrier, in fact, is provided by way of the combination of the face sheet and the foam backing material, in various possible configurations.

The face sheet and foam backing material may be secured to one another using any suitable bond or fastener. For example, in some embodiments, the face sheet and the foam backing material may be bonded together using heat, pressure, or a combination of heat and pressure, or by some other means known to those skilled in the art. Bonding may include adhesive attachment using glue. Bonding may also include fusion whereby one or both of the face sheet and foam backing solidify (e.g., after partial melting), so as to hold these two components in a fixed relationship to one another.

The protection panels may be of any suitable size. For example, in some embodiments, each protection panel may be sized to cover anywhere from 50% to 100% of the surface area of an internal wall of an elevator cab. In certain embodiments, the elevator cab wall protection panel may be rectangular and may have dimensions of from 2-3 feet in width and from 6-10 feet in height.

Any suitable apparatus or method may be used to place a protection panel adjacent to a wall in the elevator cab. For example, the protection panel may be hanged using a hanging apparatus from elevator posts positioned along a top perimeter of the elevator cab. Any suitable hanging apparatus may be used. For example, in some embodiments, the protection panel may be bent at its top to accommodate elevator posts. The panel may be designed so that it would hook onto and hang from the same elevator cab posts that the quilted fabric blankets are currently hung from. In certain embodiments, the top of the panel rests on the posts, and no mechanical/physical or permanent connection is made. In some embodiments, the protection panel may have holes situated at a top portion of the panel for hanging the panel from elevator posts. In certain embodiments, hooks may be coupled to an edge portion, such as a top edge, of the protection panel for hanging the protection panel from elevator posts. There are a variety of known mechanisms in the existing art for this purpose and it is well within the purview of a skilled person to select one.

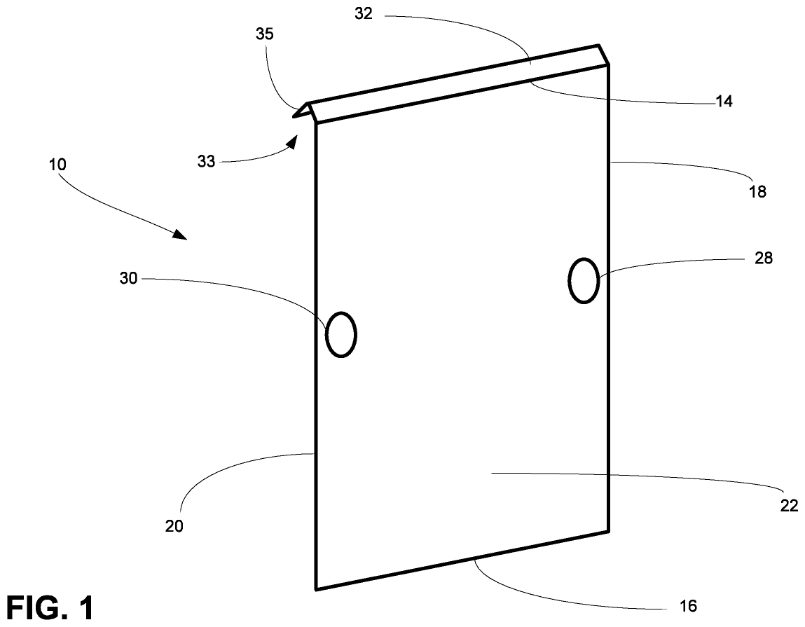

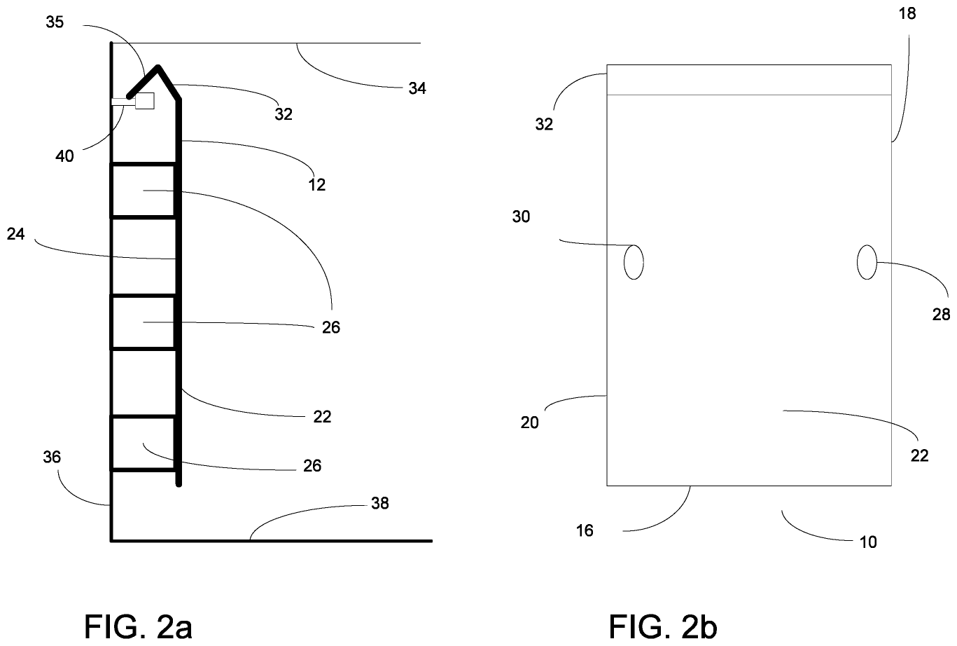

Turning to the figures, wherein like numerals represent like features on the panel. FIG. 1 shows a perspective view elevator cab wall protection panel generally indicated at 10 and having a face sheet 12 (having a top 14, a bottom 16, two opposing sides 18 and 20, a front surface 22 and a back surface 24, best shown in FIG. 2a). The panel 10 further comprises a foam backing 26, adhered to the back surface 24 of the face sheet 12 (foam best shown in FIG. 2a). Handhold cut-outs are provided in face sheet 12, and shown as 28 and 30. A hanging apparatus 33 is formed from a sheet break 32 and a hanger 35.

FIG. 2a shows a side view of the elevator cab wall protection panel 10, and specifically in situ within an elevator cab (with elevator walls noted as 34, 36, and 38). The panel 10, comprising the face sheet 12 and the foam backing 26 (in the form of horizontal strips) is hanging from an elevator cab post 40. In this embodiment, the hanger 35 bears against the elevator cab post 40 and is angled such that the foam backing 26 is pushed against the elevator wall 36. The hanger 35 may have a contact surface suitable for gripping the elevator cab post 40.

FIG. 2b shows a front view of the elevator cab wall protection panel 10 as would be visible from interior of an elevator.

In some embodiments, an elevator cab wall protection panel, for temporary installation in an elevator cab to protect an interior wall of an elevator cab against an impact force, may include a face sheet for absorbing and dispersing energy from the impact force and a reversibly deformable backing connected to a back of the face sheet for absorbing energy from the impact force when the reversibly deformable backing is pushed against the interior wall by the impact force. The reversibly deformable backing is positioned between the face sheet and the interior wall when the elevator cab wall protection panel is installed. The face sheet may have a higher rigidity than the reversibly deformable backing. The reversibly deformable backing, which may be a foam backing, may absorb energy from the impact force transferred from the face sheet. Having a rigid face sheet may allow dispersal of the energy from the impact force over a wider area than the original impact zone. The energy from the impact may then be transferred to a larger area of foam backing, thereby potentially increasing the amount of energy absorption by the foam backing.

The elevator cab wall protection panel may also include a coupling apparatus coupled to an edge of the face sheet for installing the elevator cab wall protection panel adjacent to the interior wall. In some embodiments, the coupling apparatus may include a hanging apparatus coupled to a top edge of the face sheet for hanging the elevator cab wall protection panel adjacent to the interior wall. Any suitable coupling apparatus may be used, such as holes with a bearing surface at a top edge of the hole to engage with a support, hooks, an angled portion of the face sheet for engaging with a support, chains, and fasteners such as bolts or screws.

When the elevator cab wall protection panel is in an installed position, it is in a position adjacent to an interior wall of the elevator cab. Installation may be reversible or temporary. Temporary, for the purposes of the present disclosure, means that the protection panels may be easily uninstalled without causing damage to the elevator cab.

In some embodiments, the reversibly deformable backing may have a thickness sized to allow a predetermined depth of compression upon application of a predetermined minimum force. It may be desired that the backing absorb a certain amount of energy from an impact in order to protect the elevator wall. Assuming the face sheet will cause the backing to compress equally across the sheet, the amount of energy absorption desired may be correlated to a minimum amount of compression which may in turn be correlated to a thickness of the backing that will be sufficient to allow the minimum amount of compression.

In some embodiments, the reversibly deformable backing may have a thickness sufficient to fill a space between the back of the face sheet and the interior wall when the elevator cab wall protection panel is installed in the elevator cab. The size of pre-existing hanging mechanisms in elevator cabs, such as elevator cab posts located around a perimeter near the top of the elevator cab, may be used as one factor in determining a thickness of the backing. It may be desirable, in some embodiments, to reduce or eliminate the gap between the panel and the elevator wall. Reducing the gap may reduce the impact force of the panel striking the elevator wall whenever the panel is impacted or is shoved towards the wall. The backing may act as a buffer to absorb the energy of the impact as the backing is compressed between the wall and the face sheet.

In some embodiments, the elevator cab wall protection panel may have sufficient rigidity to remain upright, during installation of the elevator cab wall protection panel, while held suspended above the ground from a central portion of each of at least one vertical axis running along the length of the elevator cab wall protection panel. A vertical axis extends from the top of the panel to the bottom when the panel is installed in the elevator cab. The protection panel may be seen to be held at a central portion of a vertical axis when it is held at a cutout around the midway point of the length of the protection panel. Remaining upright means that the protection panel does not bend over or fold.

Being able to hold the panel at the side edges or by hand cutouts close to the side edges of the panel without the panel folding allows easy installation of the panel. A person may install it simply by lifting it and hanging it from elevator cab posts, without the need for a step ladder. This is advantageous over blanket style protectors, which are held close to the top during hanging and may need to have each portion of the hanging apparatus to be individually and separately hanged from its respective elevator cab post.

The elevator cab wall protection panels may be light enough that a person of reasonable stature may lift them off and on by themselves. This is advantageous over the currently used heavy, unwieldy quilted blankets. In some embodiments, the panels may have ‘hand-holds’ cut into them for ease of use. For example, hand-holds may be cut out close to the edge of each side of the panel. For storage purposes, in some embodiments, the protection panels may be folded or rolled.

The panels may be very robust when used for their intended purpose. The panels may be more resistant to ripping, tearing, absorbing odours and housing insects than the protection blankets found in the prior art. Additionally, the face sheet may be easily cleaned. For example, in some embodiments, the face sheet may lack absorbent materials on its front surface thereby simplifying cleaning the front surface. Cleaning may be performed by spraying with a solvent and wiping clean. The ability to wipe clean is advantageous over the blanket style protectors currently in use, which require stronger and more complex cleaning techniques than smooth surfaces due to their woven or textile like surfaces.

The present disclosure also provides a method of protecting interior surfaces and decor of an elevator cab. In some embodiments, the method may include hanging vertically one or more elevator cab wall protection panels, as described above, within the elevator prior to the loading and transport of objects or things which could damage the interior surfaces and decor.

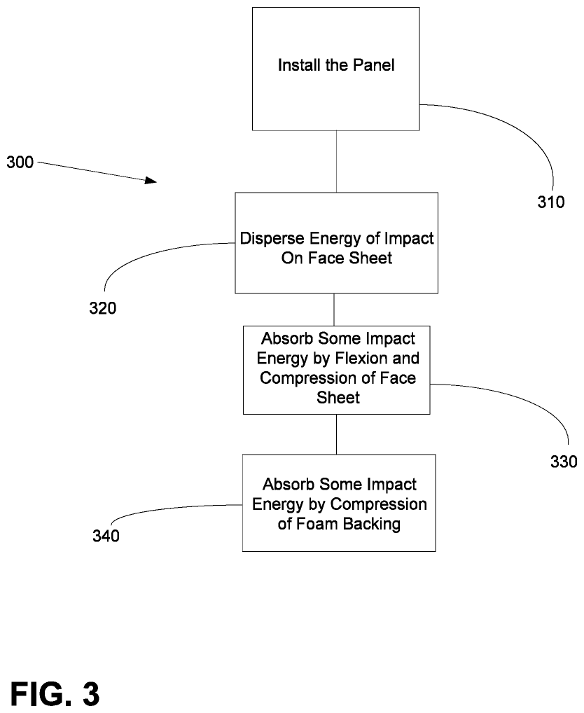

Referring to FIG. 3, a method for reducing the energy of impact forces transferred to an interior wall of an elevator cab is shown at 300. At box 310, an elevator cab wall protection panel is installed adjacent to the interior wall. In some embodiments, installation may include hanging the protection panel from pre-existing supports inside an elevator cab, such as elevator cab posts along a top perimeter of the elevator cab. The protection panel may be installed such that a back of the protection panel may be in contact with the interior wall, thus reducing the possibility of damage caused by the protection panel swinging and hitting the interior wall. At box 320, energy from an impact against the elevator cab wall protection panel is dispersed along at least a portion of a surface of a face sheet of the elevator cab wall protection panel. At box 330, some energy from the impact may be absorbed through compression and flexion of the face sheet. At box 340, some energy from the impact may be absorbed by compressing a portion of a reversibly deformable backing coupled to a back of the face sheet. The area of the compressed portion is behind the portion of the surface of the face sheet along which the energy is dispersed. The compressed portion is compressed between the face sheet, which has a higher rigidity than the reversibly deformable backing, and the interior wall. The elevator cab wall protection panel may have sufficient rigidity to be held suspended midway along a vertical axis without folding during hanging of the elevator cab wall protection panel.

### Face Sheet Materials

Any suitable material may be used to make the face sheet. In some embodiments, the material used for the face sheet may be comprised of, for example and without limitation, a polymer, copolymer or homopolymer having a low density and being injection moldable or extrudable in a sheet manufacturing process to form a lightweight thermoplastic sheet. Non-limiting examples of polymers include polyethylene (low-density polyethylene, medium-density polyethylene, high-density polyethylene, and linear low-density polyethylene); polypropylene, polyester, nylon and polyvinyl chloride.

Example of thermoplastic polymers useful as a face sheet material include ABS, a terpolymer made by polymerizing styrene and acrylonitrile in the presence of polybutadiene. The proportions can vary from 15 to 35% acrylonitrile, 5 to 30% butadiene and 40 to 60% styrene resulting in a long chain of polybutadiene crisscrossed with shorter chains of poly(styrene-co-acrylonitrile).

ABS plastic sheets combine high impact resistance and ease of cleaning. ABS-sheets may be produced by monolayer or monolayer or multilayer extrusion. ABS-sheets can be made with smooth or structural surfaces and various colors or gradations which include matte finishes.

In some embodiments, the face sheet material may be comprised of ABS/PC, i.e. composite material sheets of polycarbonate (PC) and acrylonitrile butadiene styrene (ABS). In certain embodiments, the face sheet material may be comprised of HIPS (high-impact polystyrene), high density polyethylene (HDPE). In some embodiments, the face sheet material may be comprised of ABS/TPU, multi-layer sheets with a soft surface layer of thermoplastic polyurethane (TPU) and acrylonitrile butadiene styrene (ABS) to provide high wear resistance, and scratch resistance.

The face sheet material may be of any suitable thickness. For example, in some embodiments, the face material may be about ⅛″ in thickness.

### Foam Backing Material/Pieces

Any material having a suitable density and resilience for the intended barrier purpose may be used as the foam backing.

Regarding to foam properties, density refers the mass per unit volume, measured and expressed in pounds per cubic foot (pcf) or kilograms per cubic meter (kg/m3). It is a function of the chemistry used to produce the foam. Foams with higher density have more foam per cubic meter and have superior resistance to loss of hardness or height/thickness compared to lower density foams and are also more expensive due to their higher material content.

Resilience is a measure of the foam's “bounce” or springiness, and its reconfiguration back to original form after pressure or impact. The resilience of foam is found by dropping a steel ball onto a standard sized test piece and measuring the distance that the ball bounces back. The height the ball was dropped from divided by the bounce height equals the foams resilience percentage. Foams with resilience above 50% are classified as high Resilience and those with resilience below 10% are classified as Low Resilience. An example of superior resilience foam is Dunlop Foams Enduro™-EN36-100, which has a resilience factor of 55%.

Dynamic fatigue refers to how well foam retains its original firmness properties and height over time. Virtually all tests are based on flexing or compressing the foam a specific number of times and measuring foam firmness and height before and after testing. In flex fatigue testing, foam samples may be compressed a few thousand times, or many thousands of times. The percentage of IFD loss is then measured. Shorter tests provide an idea of how much firmness a foam may lose through initial use, while longer tests provide data on overall foam durability.

Within the scope of the present disclosure, various types of foams may be used, including, without limitation, any suitable polymer elastomer, such as, for example, polyether, polyester, polyurethane, polyethylene, (such as, for example, Ethafoam™, polystyrene, closed cell sponge rubber, open cell sponge rubber, latex rubber, high density foams, and high resilience foams.

In one embodiment, polymer foam comprising a polymer elastomer that has a compression index ranging from about 0.4 to about 0.8 may be used. As described further herein, this compression enables “push-back” when the elevator panel (particularly the foam backing) is stressed by engagement with an object pushing there against.

In some embodiments, the polymer foam material used for the backing may be expanded polystyrene (EPS). EPS is commercially available in large sizes and in a variety of densities. In some aspects, the EPS may have a density of between about 0.5 pounds per cubic foot (PCF) and about 2.0 PCF. Examples grades of EPS that may be used include, without limitation, ASTM C 578 Type XI (0.70-0.89 PCF), Type I (0.9-1.14 PCF), Type VIII (1.15-1.34 PCF), Type II (1.35-1.79 PCF), and Type IX (1.80-2.20 PCF). Other grades of EPS foam and/or or other densities may alternatively be used. EPS may be formed into strips, bands or sections having the desired dimensions for backing the face sheet as desired from prefabricated sheets. EPS may also or alternatively be obtained in large blocks from which strips, bands or sections having the desired dimensions may be cut using known techniques (e.g., using an electric hot wire cutting tool).

EPS is highly shock absorbent and has a high compressive strength. Moreover, EPS is elastic. After being compressed, an EPS sheet returns to its original shape when the compressive force is removed. EPS is extremely lightweight, an advantage for use within the panel of the present disclosure.

The panel of the present disclosure is not limited to any one foam type so long as suitable buffer and protective functionalities are provided. Polymer foams are available in a variety of densities and thicknesses and may comprise special additional options such as being anti-static, non-abrasive, and recycled.

Regarding the configuration of the foam backing on the back surface of the face sheet, in some embodiments, the panel may comprise a plurality of spaced-apart foam bands or strips extending horizontally across or vertically down the back surface of the face sheet or in any other suitable direction. In certain embodiments, the panel may comprise a foam sheet adhered to some or all of the back surface of the face sheet. In some embodiments, the panel may comprise a foam sheet adhered to the back surface of the face sheet in geometric cutouts, such as, for example and without limitation, cubes.

In certain embodiments, the foam backing on the back surface of the face sheet may comprise a plurality of foam strips spaced apart and extending horizontally across the back surface of the face sheet.

Any suitable thickness of foam backing may be used. In some embodiments, the foam backing may be of a thickness to fill or substantially fill the space that exists between the face sheet and the elevator wall, when the panel is hanging in use. Reducing the gap between the panel and the elevator wall may reduce the force of potential impacts of the panel swinging into the wall. In embodiments where the thickness of the foam backing is such that the foam backing remains in contact with the elevator wall when the panel is hanging in position, there may be no direct impact caused by the panel swinging into the wall whenever a force impacts the panel.

The face sheet, being more rigid than the foam backing, in addition to absorbing some energy from the initial impact, may disperse the force caused by an impact across a portion of the face sheet. Dispersal of the force may cause an area larger than the area of initial impact to move in towards the wall. Increasing the area of the face sheet in which the impact force disperses may increase the size of foam backing for absorbing energy from the impact as the foam is compressed between the wall and the face sheet.

In some embodiments, the face sheet may be sufficiently rigid that impacts of a force below some maximum force may result in dispersal across the entire face sheet, resulting in the entire face sheet being pushed towards the wall with equal force. This may allow maximum absorption of the energy from the initial impact by the foam, thereby transferring minimal energy to the elevator wall and thus reducing the chance of damage to the wall. The depth and placement of the foam may buffer against impacts, which is an advantage over protection blankets currently in use.

A few additional advantages of the panel and system of panels of the invention may include, without limitation, superior, lightweight elevator cab wall protection as compared to existing blanket style protection systems, relatively cost efficient materials, highly durability, simple installation using hand hold cut outs for easy gripping while hanging the panels and relatively easy cleaning due to a non-absorbent face-sheet that may repel solids, liquids, and odours.

### Alternative Embodiments

Optionally, in some embodiments, the face material and/or foam backing may comprise or be coated with a flame retardant. For example, the face material and foam backing may contain from between about 5% to about 20% flame retardant. A good flame retardant is Extensity 0201-127 commercially sold by Saco AE Polymers, 3220 Crocker Ave., Sheboygan, Wis. 53081. Decabromodiphenyl ethane, such as FR-1410, is another good flame retardant. FR-1410 is manufactured by ICL Industrial Products, having a corporate headquarter at Makeleff house, 12 Kroitzer Street, P.O. Box 180 Beer Sheva, 84101 Israel.

In some embodiments, rather than hanging the protection panels, the protection panels may be installed adjacent to a wall in an elevator cab using other suitable coupling methods or apparatus. For example, in some embodiments, a protection panel may rest on the floor of the elevator cab. A suitable coupling method may be used to temporarily secure the protection panel to an elevator cab post or any suitable support in the elevator cab so that the protection panel does not fall over.

It is contemplated that any part of any aspect or embodiment discussed in this specification can be implemented or combined with any part of any other aspect or embodiment discussed in this specification.

While particular embodiments have been described in the foregoing, it is to be understood that other embodiments are possible and are intended to be included herein. It will be clear to any person skilled in the art that modifications of and adjustments to the foregoing embodiments, not shown, are possible.

1. An elevator cab wall protection panel, for removable hanging in an elevator comprises:
(a) a face sheet having a top, a bottom, two opposing sides, a front surface and a back surface, wherein face sheet is substantially flat, and of flexible and lightweight material and wherein front surface of said sheet, when the panel is in place and hanging in an elevator, is exposed and visible to an interior of the elevator; and
(b) a foam backing adhered to the back surface of the face sheet and having sufficient thickness and compression rigidity to buffer impacts to the elevator cab wall, during moving of objects in the elevator.

2. The elevator cab wall protection panel of claim 1 wherein the foam backing comprises a plurality of foam bands extending horizontally across the back surface of the face sheet.

3. The elevator cab wall protection panel of claim 1 wherein the foam backing comprises a plurality of foam bands extending vertically down the back surface of the face sheet.

4. The elevator cab wall protection panel of claim 1 wherein the foam backing comprises a plurality of foam strips.

5. The elevator cab wall protection panel of claim 1 wherein the foam backing comprises a foam sheet adhered to at least some part of the back surface of the face sheet.

6. The elevator cab will protection panel of claim 1 wherein the face sheet comprises one or more hand cut outs for ease in hanging.

7. The elevator cab wall protection panel of claim 1 wherein the face sheet is comprised of at least one of a polymer, copolymer or homopolymer based material.

8. The elevator cab wall protection panel of claim 1 wherein the foam backing is comprised of at least one or more of polymer elastomer, polystyrene, closed cell sponge rubber, open cell sponge rubber, latex rubber, high density foams, and high resilience foams.

9. The elevator cab wall protection panel of claim 1 wherein the foam backing is of a depth to fill or substantially fill a space between the face sheet and the elevator wall, when the elevator cab wall protection panel is installed.

10. The elevator cab wall protection panel of claim 1 wherein the elevator cab wall protection panel is rectangular.

11. The elevator cab wall protection panel of clam 1 wherein the elevator cab wall protection panel is rectangular and 2-3 feet in width and 6-10 feet in height.

12. The elevator cab wall protection panel of claim 1 further comprising a hanger coupled to a top portion of the face sheet for hanging the elevator cab wall protection panel from elevator posts located at a top portion of the elevator cab.

13. The elevator cab wall protection panel of claim 12 wherein the hanger comprises a bearing portion for bearing against a top surface of the elevator posts and wherein the bearing portion extends down from a top portion of the face sheet.

14. An elevator cab wall protection panel, for temporary installation in an elevator cab to protect an interior wall of an elevator cab against an impact force, comprising:
(a) a face sheet for absorbing and dispersing energy from the impact force;
(b) a reversibly deformable backing connected to a back of the face sheet for absorbing energy from the impact force when the reversibly deformable backing is compressed against the interior wall by the impact force, wherein the reversibly deformable backing is positioned between the face sheet and the interior wall when the elevator cab wall protection panel is installed and wherein the face sheet has a higher rigidity than the reversibly deformable backing; and
(c) a coupling apparatus coupled to an edge of the face sheet for reversibly installing the elevator cab wall protection panel adjacent to the interior wall.

15. The elevator cab wall protection panel of claim 14 wherein the elevator cab wall protection panel has sufficient rigidity to remain upright, during installation of the elevator cab wall protection panel, while held suspended above the ground from a central portion of each of at least one vertical axis running along the length of the elevator cab wall protection panel.

16. The elevator cab wall protection panel of claim 14 wherein the coupling apparatus comprises a hanging apparatus coupled to a top edge of the face sheet for hanging the elevator cab wall protection panel adjacent to the interior wall.

17. The elevator cab wall protection panel of claim 14 wherein the reversibly deformable backing has a thickness sized to allow a predetermined depth of compression upon application of a predetermined minimum force.

18. The elevator cab wall protection panel of claim 14 wherein the reversibly deformable backing has a thickness sufficient to fill a space between the back of the face sheet and the interior wall when the elevator cab wall protection panel is installed in the elevator cab.

19. A method for reducing the energy of impact forces transferred to an interior wall of an elevator cab, the method comprising:
(a) installing an elevator cab wall protection panel adjacent to the interior wall;
(b) dispersing energy from an impact against the elevator cab wall protection panel along at least a portion of a surface of a face sheet of the elevator cab wall protection panel;
(c) absorbing energy from the impact through compression and flexion of the face sheet; and
(d) absorbing energy from the impact by compressing a portion of a reversibly deformable backing coupled to a back of the face sheet, wherein the area of the compressed portion is behind the portion of the surface of the face sheet along which the energy is dispersed and wherein the compressed portion is compressed between the face sheet, which has a higher rigidity than the reversibly deformable backing, and the interior wall.

20. The method of claim 19 wherein the elevator cab wall protection panel has sufficient rigidity to remain upright, during installation of the elevator cab wall protection panel, while held suspended above the ground from a central portion of each of at least one vertical axis running along the length of the elevator cab wall protection panel.

21. The method of claim 19 wherein installing comprises hanging the elevator cab wall protection panel from pre-existing supports inside an elevator cab using hangers coupled to a top edge of the elevator cab wall protection panel.
